(19) United States
(12) Patent Application Publication
(10) Pub. No.: US 2005/0287436 A1
(43) Pub. Date: Dec. 29, 2005

(54) Vanadium redox flow battery electrolyte-use amorphous solid composition

(76) Inventors: Yasumasa Kawashige, Sakai-shi (JP); Makoto Sugahara, Sakai-shi (JP); Hiromi Takada, Sakai-shi (JP)

Correspondence Address: BIRCH STEWART KOLASCH & BIRCH, PO BOX 747, FALLS CHURCH, VA, 22040-0747, US

(21) Appl. No.: 10/513,855

(22) PCT Filed: May 6, 2003
(86) PCT No.: PCT/JP03/05647

§ 371 Date: Jul. 13, 2005

(30) Foreign Application Priority Data
May 10, 2002 (JP) 2002135812

(51) Int. Cl. H01M 6/04

(52) U.S. Cl. 429/189

(57) ABSTRACT

An amorphous solid composition for a vanadium redox flow battery electrolyte, which can be suitably used for storage of excess electric power for using in daytime, generated in nighttime by a power station, storage of electric power generated by photovoltaic power generation or wind power generation, and the like. The amorphous solid composition for vanadium flow battery electrolyte is characterized in that the weight ratio of the vanadium content in the tetravalent vanadium ions to the vanadium content in the trivalent vanadium ions is 4.5:5.5 to 5.5:4.5, and that the composition exists within the region circumscribed by a straight line A-B, a straight line B-E, a straight line E-F and a straight line F-A, wherein these lines are formed by joining point A (1.25, 23.2), point B (1.25, 20.4), point E (1.60, 18.4) and point F (1.60, 21.2), respectively, in an x-y coordinate system in which the total vanadium content (% by weight) of the tetravalent vanadium ions and the trivalent vanadium ions in the composition is defined as a y-coordinate, a value obtained by dividing the total amount of the tetravalent vanadium ions and the trivalent vanadium ions by 50.94 is defined as a value, a value obtained by dividing the content of sulfate ions in the composition by 96.1 is defined as b value, and a value obtained by dividing b value by a value is defined as an x-coordinate.

### TECHNICAL FIELD

The present invention relates to an amorphous solid composition for a vanadium redox flow battery electrolyte. More specifically, the present invention relates to an amorphous solid composition for a vanadium redox flow battery electrolyte, which can be suitably used for storage of excess electric power for using in daytime, generated in nighttime by a power station, storage of electric power generated by photovoltaic power generation or wind power generation and the like.

### BACKGROUND ART

In recent years, necessity for storage of electric power has been required more and more. Particularly, in order to effectively use excess nighttime electric power, it has been remarked to use nighttime electric power for pumping water up in a pumped-storage power station. However, our country is so narrow that construction of the station is restricted from the viewpoint of locational conditions.

Also, it has been desired in remote places to store electric power obtained by photovoltaic power generation or wind power generation, which can be used when needed. In order to store the electric power, a secondary battery having a large capacity and being economical is required. As a battery suitable for this secondary battery, attention has been given to a vanadium redox flow battery.

As an electrolyte for use in a vanadium redox flow battery, an electrolyte for a vanadium redox flow battery has been used. This electrolyte for a vanadium redox flow battery has an advantage such that the higher the vanadium concentration is, the greater the ability per unit volume of a battery becomes. However, on the other hand, when the vanadium concentration increases, crystals of a vanadium compound easily precipitates. In order to suppress the formation of the crystals, some attempts have been made by including various additives in an electrolyte, and some effects have been recognized to a certain extent. However, it has been desired to develop an electrolyte having a higher vanadium concentration.

As electrolytes containing vanadium, there have been known an electrolyte for a positive electrode containing tetravalent vanadium ions and sulfate ions, an electrolyte for a negative electrode containing trivalent vanadium ions and sulfate ions, a starting electrolyte for common use of a positive electrode and a negative electrode containing tetravalent vanadium ions, trivalent vanadium ions and sulfate ions, and the like.

However, these electrolytes have a low vanadium concentration of 2 mol/L or so. Therefore, the improvement in not only ability per unit volume of the battery but also storage stability and transportation cost of the electrolyte has been desired. In addition, since the amount of vanadium contained in the electrolyte differs depending upon the kinds of the batteries used, a variety of electrolytes must be previously prepared. Furthermore, since an aqueous sulfuric acid is generally used as a solvent in the electrolyte, not only an acid-resistant vessel for liquids would be necessitated, but also improvement in safety against human bodies has been desired.

### DISCLOSURE OF INVENTION

In view of the above-mentioned prior art, an object of the present invention is to provide a solid composition for a vanadium flow battery electrolyte being excellent in water solubility, which gives an electrolyte for a vanadium flow battery.

The present invention relates to an amorphous solid composition for a vanadium flow battery electrolyte (hereinafter referred to as “solid composition”) containing tetravalent vanadium ions, trivalent vanadium ions, water and sulfate ions. The solid composition is characterized in that the weight ratio of the vanadium content in the tetravalent vanadium ions to the vanadium content in the trivalent vanadium ions is 4.5:5.5 to 5.5:4.5, and that the composition exists within the region circumscribed by a straight line A-B, a straight line B-E, a straight line E-F and a straight line F-A, wherein these lines are formed by joining point A (1.25, 23.2), point B (1.25, 20.4), point E (1.60, 18.4) and point F (1.60, 21.2), respectively, in an x-y coordinate system in which the total vanadium content (% by weight) of the tetravalent vanadium ions and the trivalent vanadium ions in the composition is defined as a y-coordinate, a value obtained by dividing the total amount of the tetravalent vanadium ions and the trivalent vanadium ions by 50.94 is defined as a value, a value obtained by dividing the content of sulfate ions in the composition by 96.1 is defined as b value, and a value obtained by dividing b value by a value is defined as an x-coordinate.

### BRIEF DESCRIPTION OF THE DRAWINGS

FIG. 1 is a graph showing an x-y coordinate system in which a value obtained by dividing a value (b value), which is obtained by dividing the content of sulfuric acid in the composition by 96.1, by a value (a value), which is obtained by dividing the total amount of the tetravalent vanadium ions and the trivalent vanadium ions by 50.94, is defined as an x-coordinate, and the total vanadium content (% by weight) of the tetravalent vanadium ions and the trivalent vanadium ions in the composition is defined as a y-coordinate in the amorphous solid composition for a vanadium flow battery electrolyte of the present invention.

FIG. 2 is a graph showing the relationship between X value and Y value, in which a value obtained by dividing the total amount of the tetravalent vanadium ions and the trivalent vanadium ions in the liquid composition for preparing the solid composition by 50.94 is defined as Y value, a value obtained by dividing the content of sulfuric acid in the composition by 96.1 is defined as Z value, and a value (Y/Z) obtained by dividing Y value by Z value is regarded as X value. In FIG. 2, region I is a region of an amorphous solid composition of the present invention, region II is a region adjacent to region I. The solid composition existing in this region I has crystallinity and water solubility, but apparently shows a water solubility lower than the amorphous solid composition of region I. The region II is hereinafter referred to as a region of the adjacent solid composition. The compositions existing in region II are described in reference examples herein.

FIG. 3 is a graph showing the results of thermogravimetric analysis of the solid compositions obtained in Example 6 and Example 8 of the present invention, and the solid compositions obtained in Reference Example 5, Reference Example 10, Reference Example 13 and Reference Example 18.

FIG. 4 is a graph showing the results of simultaneous determination of thermogravimetric analysis, derivative thermogravimetry (DTG) and differential thermal analysis of the solid composition obtained in Example 6 of the present invention.

FIG. 5 is a graph showing the results of simultaneous determination of thermogravimetric analysis, derivative thermogravimetry (DTG) and differential thermal analysis of the solid composition obtained in Example 8 of the present invention.

FIG. 6 is a graph showing the results of simultaneous determination of thermogravimetric analysis, derivative thermogravimetry (DTG) and differential thermal analysis of the solid composition obtained in Reference Example 5.

FIG. 7 is a graph showing the results of simultaneous determination of thermogravimetric analysis, derivative thermogravimetry (DTG) and differential thermal analysis of the solid composition obtained in Reference Example 13.

FIG. 8 is a graph showing the results of simultaneous determination of thermogravimetric analysis, derivative thermogravimetry (DTG) and differential thermal analysis of the solid composition obtained in Reference Example 18.

FIG. 9 shows powdered X-ray diffraction patterns (a) to (f) of the solid compositions obtained in Example 6, Example 8, Example 10, Example 13 and Example 14 of the present invention, and Reference Example 2 in order.

### BEST MODE FOR CARRYING OUT THE INVENTION

The amorphous solid composition of the present invention contains tetravalent vanadium ions, trivalent vanadium ions, sulfuric acid and water.

In the aqueous sulfuric acid containing vanadium ions, which is obtained by mixing tetravalent vanadium ions with trivalent vanadium ions in an approximately equimolecular amount, when the amount of sulfuric acid and the amount of the vanadium ions contained in the aqueous sulfuric acid are controlled, it has been found out that the solution for the solid composition can be easily concentrated by means such as evaporation to dryness, and that the solid composition obtained is amorphous and excellent in water solubility.

Furthermore, it has been found out that an electrolyte containing various components can be easily prepared by controlling the amount of water and the amount of sulfuric acid when the electrolyte is prepared from this amorphous solid composition.

The present invention has been accomplished on the basis of these findings.

In the vanadium redox flow battery, it has been known that the following reactions occur on the positive electrode and the negative electrode during charging, and that their reverse reactions occur on the positive electrode and the negative electrode during discharging.
(Positive Electrode) V⁴⁺→V⁵⁺+e⁻
(Negative Electrode) V³⁺+e⁻→V²⁺

Accordingly, in an initial vanadium redox flow battery, a positive electrode room is usually charged with an electrolyte containing tetravalent vanadium ions, and a negative electrode room is usually charged with an electrolyte containing trivalent vanadium ions. However, in order to develop an electrolyte which can be commonly used in the positive room and the negative room from the viewpoint of rationalizing the electrolyte, an electrolyte containing tetravalent vanadium ions and trivalent vanadium ions in an equimolar ratio has been used as an electrolyte recently.

When this electrolyte containing tetravalent vanadium ions and trivalent vanadium ions in an equimolar ratio is used, it has been known that the following reactions occur on the positive electrode and the negative electrode during charging, and that their reverse reactions occur on the positive electrode and the negative electrode during discharging.
(Positive Electrode) V⁴⁺→V⁵⁺+e⁻
V³⁺→V⁵⁺+2e⁻
(Negative Electrode) V³⁺+e⁻→V²⁺
V⁴⁺+2e⁻→V²⁺

However, when the tetravalent vanadium ions and the trivalent vanadium ions are not contained in this electrolyte in an equimolar ratio, the following phenomenon occurs:

For instance, the concentration of V³⁺ in the electrolyte is defined as p, and the concentration of V⁴⁺ is defined as q. When concentration q is higher than concentration p, charging capacitance of (2p+q) F is required for the positive electrode, and charging capacitance of (p+2q) F is required for the negative electrode during charging.

However, since (p+2q) F is greater than (2p+q) F, the charging on the positive electrode is finished prior to the finish of charging on the negative electrode. Therefore, all of V on the positive electrode are converted into V⁵⁺; whereas on the negative electrode, normal charging such that all of V are converted into V²⁺ cannot be achieved, because no more charging progresses. Accordingly, charging on the negative electrode becomes insufficient.

For instance, when the V³⁺ concentration p is 0.4 and the V⁴⁺ concentration q is 0.6, the charging capability[(2p+q)/[p+2q]×100] is calculated to be 1.4/1.6×100=87.5%, and does not approximates to 100%.

Accordingly, in the present invention, in order to increase the charging capability and avoid the electric polarization during charging of a battery, the weight ratio of the vanadium content of the tetravalent vanadium ions to the vanadium content of the trivalent vanadium ions (tetravalent vanadium ions/trivalent vanadium ions) is controlled to 4.5:5.5 to 5.5:4.5, preferably 4.7:5.3 to 5.3:4.7 in consideration of the fact that the battery is not usually thoroughly charged. As described above, when the above molar ratio is controlled to a given value, the charging capability can be adjusted to at least 93.5%. Also, if the above weight ratio is 4.5:5.5 to 5.5:4.5, then the average valency of the entire vanadium ions will be 3.45 to 3.55, according to an expression way usually employed in the field of batteries.

The term “charging capability” (%) as referred to herein is intended to mean a value obtained by dividing the smallest charge capacitance in the charge capacitances of the positive electrode and the negative electrode by a charge capacitance of the largest charge capacitance in the charge capacitances of the positive electrode and the negative electrode, and multiplying the resultant value by a factor of 100.

The tetravalent vanadium ions are not recognized to exist in the form of V⁴⁺ as it is in solids or solutions, and exist in the form of VO²⁺ or [VO(H₂O)₅]²⁺. The latter form is called vanadium(IV) penta-aqua cation.

The trivalent vanadium ions exist in the form of V³⁺ in solids, for instance, slightly water-soluble solid vanadium(III) sulfate or a hydrate thereof.

On the other hand, the trivalent vanadium ions exist in the form of [V(H₂O)₆]²⁺, that is, vanadium(IV) hexa-aqua cation in aqueous solutions or solids having a high water solubility as in the present invention.

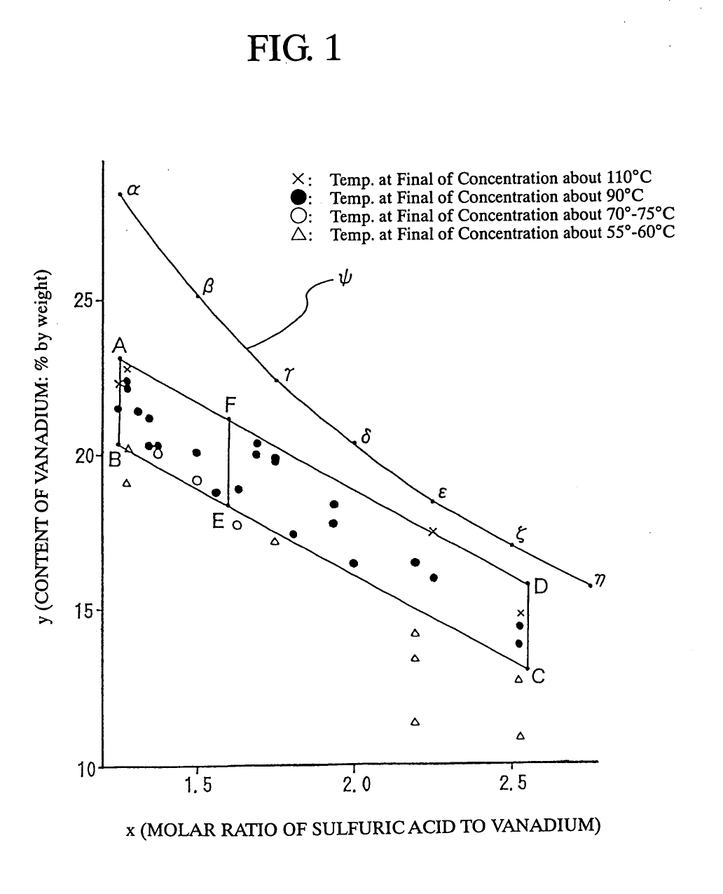

The x-y coordinate system will be explained, in which the total vanadium content (% by weight) of the tetravalent vanadium ions and the trivalent vanadium ions in the amorphous solid composition of the present invention is defined as y-coordinate; the value obtained by dividing the total amount of the tetravalent vanadium ions and the trivalent vanadium ions by 50.94 is defined as a value; the value obtained by dividing the content of sulfate ions in the composition by 96.1 is defined as b value; and the value obtained by dividing b value by a value [molar ratio of sulfate ion to vanadium] is defined as x-coordinate. This x-y coordinate system is shown in FIG. 1.

The amorphous solid composition of the present invention is extremely excellent in water solubility, has high transparency and is glassy, but does not show a glass transition state as in glass even though heated to melt. The amorphous solid composition is included in the region circumscribed by a straight line A-B, a straight line B-E, a straight line E-F and a straight line F-A, wherein these lines are formed by joining point A (1.25, 23.2), point B (1.25, 20.4), point E (1.60, 18.4) and point F (1.60, 21.2), respectively, in the x-y coordinate system shown in FIG. 1.

On the other hand, a composition included in the region circumscribed by a straight line F-E, a straight line E-C, a straight line C-D and a straight line D-F, wherein these lines are formed by joining point E (1.60, 18.4), point F (1.60, 21.2), point C (2.55, 13.0) and point D (2.55, 15.8), respectively, in the above-mentioned x-y coordinate system (hereinafter the composition is referred to as adjacent solid composition) has an advantage such that its water solubility is excellent. Also, x value in this adjacent solid composition is 1.60 to 2.55, while x value in the electrolyte usually used is 1.5 to 2.55. Therefore, the adjacent solid composition has an advantage such that an electrolyte can be obtained from the adjacent solid composition by simply dissolving the adjacent solid composition in water without troublesome procedures such as adjustment of the concentration of sulfuric acid. Both of the amorphous solid composition of the present invention and the adjacent solid composition are solid compositions being excellent or good in water solubility, which provide an electrolyte for vanadium redox flow batteries.

However, the amorphous solid composition of the present invention has deep green gloss and is brittle like “caramelo”, and its water solubility is at most 5 minutes when determined by the test method described in the following Examples.

On the other hand, the dissolving time of the adjacent solid composition is at least 10 minutes, and a composition apart from the amorphous solid composition of the present invention has a dissolving time of at least half of a day.

The amorphous solid composition of the present invention can be easily handled during or after its preparation, because the amorphous solid composition is an amorphous composition being brittle like “caramelo” and not causing solidification, adhesion or the like.

On the other hand, the adjacent solid composition is a hard crystalline solid having yellow-green color or green color, and has some disadvantage such that the composition easily solidifies and easily adheres to an equipment.

From these circumstances, it can be said that the amorphous solid composition of the present invention has more advantageous merits in practical use than the adjacent solid composition.

Next, processes for preparing the amorphous solid composition of the present invention and the adjacent composition will be explained below more specifically.

The amorphous solid composition of the present invention is prepared by firstly preparing a liquid composition containing tetravalent vanadium ions, trivalent vanadium ions, sulfate ions and water in a given ratio and then concentrating the liquid composition until solids are precipitated.

In other words, firstly, an aqueous sulfuric acid solution is prepared as described below, then the amounts of the raw materials containing a tetravalent vanadium compound and a trivalent vanadium compound are adjusted so that the weight ratio of the vanadium content in the tetravalent vanadium ions to the vanadium content in the trivalent vanadium ions contained in the solution is 4.5:5.5 to 5.5:4.5, and the raw materials are dissolved in the aqueous sulfuric acid.

As the raw materials, vanadium dioxide (VO₂), vanadium trioxide (V₂O₃) or lower oxides of vanadium containing these vanadium oxides, vanadium(IV) sulfate (VOSO₄.nH₂O), vanadium(III) sulfate [V₂(SO₄)₃.nH₂O] (n is 0 or an integer of 2 to 5, hereinafter referred to the same) and the like can be used.

Also, in order to adjust the ratio of the trivalent vanadium ions to the tetravalent vanadium ions, vanadium pentoxide (V₂O₅) can be used to increase the valency of the tetravalent vanadium ions. In this case, pentavalent vanadium ions are reduced to tetravalent vanadium ions.

As the aqueous sulfuric acid, the following aqueous sulfuric acid can be used: A value obtained by dividing the total amount of the tetravalent vanadium ions and the trivalent vanadium ions by 50.94 (formula weights of the tetravalent vanadium ions and the trivalent vanadium ions) is defined as a value, a value obtained by dividing the content of sulfate ions contained in the composition by 96.1 (formula weight of the sulfate ions) is defined as b value, and a value obtained by dividing b value by a value is defined as x value. As the aqueous sulfuric acid, there can be used an aqueous sulfuric acid containing sulfate ions, x value of which satisfies a given value in the amorphous solid composition or the adjacent solid composition.

A liquid composition for preparing the amorphous solid composition of the present invention and the adjacent solid composition obtained in the subsequent evaporation step for concentration can be prepared by dissolving the raw materials, the kinds and amounts of which have been previously adjusted.

In the components of the liquid composition for preparing this amorphous solid composition, the total vanadium concentration of the tetravalent vanadium ions and the trivalent vanadium ions is defied as Y (mol/L), the concentration of sulfuric acid is defined as Z (mol/L), the ratio (Z/Y) of the concentration of sulfuric acid (Z) to the total vanadium concentration of the tetravalent vanadium ions and the trivalent vanadium ions (Y) [(concentration of sulfuric acid (Z))/(total vanadium concentration of the tetravalent vanadium ions and the trivalent vanadium ions (Y))] is defined as X.

The solid composition can be obtained by adjusting the amount of sulfuric acid contained in the liquid composition for preparing the solid composition so that a given range included in the X-Y coordinate system where the both axes are formed by X and Y is included in a region determined by the x-y coordinate system of the above-mentioned solid composition after evaporation to dryness.

In this connection, X value of the liquid composition substantially coincide with x value of the solid composition.

Furthermore, embodiment of the conditions for preparing the liquid composition for use in the preparation of the solid composition and the solid composition will be explained more specifically.

As the raw materials for preparing these compositions, pure vanadium(III) oxide and pure vanadium(IV) oxide can be used as a matter of course. However, since these raw materials are expensive in many cases, lower oxides of vanadium, vanadium(IV) sulfate (VOSO₄.nH₂O) or vanadium(V) oxide can be usually used as a raw material.

A desired dissolving process comprises the steps of adding vanadium(III) oxide or a lower oxide of vanadium, that is, a mixture of vanadium(III) oxide and vanadium(IV) oxide to an aqueous sulfuric acid having a sulfuric acid concentration of at least 40%, preferably 45 to 65%, and heating the mixture to a temperature of 115° to 125° C. to dissolve.

In this case, when the sulfuric acid concentration is at most 45% or the temperature is at most 115° C., all of vanadium(III) oxide would not be transformed into vanadium(III) sulfate, and a lot of vanadium(III) oxide would remain as it is, since the reaction of vanadium(III) oxide with sulfuric acid does not sufficiently progress.

On the contrary, when the sulfuric acid concentration is at least 65% or the temperature is at least 125° C., vanadium(III) sulfate•hydrate [V₂(SO₄)₃.nH₂O] would remarkably precipitate, although vanadium(III) oxide is sufficiently reacted with sulfuric acid.

The precipitated vanadium(III) sulfate•hydrate [V₂(SO₄)₃.nH₂O] obtained in this dissolution can be dissolved by adding water to the precipitates and keeping the temperature of the mixture obtained at not more than 125° C. in a subsequent procedure.

However, it is preferable to avoid the formation of the precipitate or employ dissolution conditions for minimizing this formation.

When the sulfuric acid concentration attains to at least 85% and the temperature to at least 160° C., slightly water-soluble anhydrous sulfate [V₂(SO₄)₃] would be formed.

This slightly water-soluble anhydrous vanadium(III) sulfate [V₂(SO₄)₃] can be also dissolved by adding water to the sulfate and keeping the temperature of the mixture obtained at not more than 125° C. in a subsequent procedure.

When the lower oxide of vanadium contains vanadium(III) oxide more than vanadium(IV) oxide, it is preferable that vanadium(IV) sulfate [VOSO₄.nH₂O] or vanadium oxide [(V)(V₂O₅)] is added at an appropriate time during or after dissolving the raw materials in order to adjust the ratio of the tetravalent vanadium ions to the trivalent vanadium ions. This adjustment also can be carried out by adding vanadium oxide [(V)(V₂O₅)].

On the contrary, when the vanadium lower oxides contain vanadium(IV) oxide more than vanadium(III) oxide, a lower oxide of vanadium containing vanadium(III) oxide more than vanadium(IV) oxide can be used for this adjustment in order to adjust the ratio of the tetravalent vanadium ions to the trivalent vanadium ions after dissolution.

The amorphous solid composition of the present invention and the adjacent solid composition can be prepared by, for instance, the following methods.

Firstly, a solution for the amorphous solid composition of the present invention is prepared by the method as described above so that the composition is included in the region circumscribed by a straight line \textcircled{1}-\textcircled{2}, a straight line \textcircled{2}-\textcircled{5}, a straight line \textcircled{5}-\textcircled{6} and a straight line \textcircled{5}-\textcircled{6}, in which these lines are formed by joining point \textcircled{1} (1.25, 6.5), point \textcircled{2} (1.60, 5.0), point \textcircled{5} (1.60, 1.0) and point \textcircled{6} (1.25, 1.0), respectively in the X-Y coordinate system.

Next, the amorphous solid composition can be allowed to precipitate by drying the above-mentioned solution for the solid composition under reduced pressure. The conditions for drying under reduced pressure, for instance, degree of reduced pressure and temperature, can be arbitrarily and widely controlled.

However, in the final stage of drying the solution for the solid composition, if the heating temperature is so low, then the solution cannot be sufficiently dehydrated. Therefore, it is desired that the heating temperature is at least 60° C., preferably at least 80° C.

Thus, the amorphous solid composition of the present invention can be obtained.

When the adjacent solid composition is prepared, a solution for the adjacent solid composition can be prepared by the method as described above so that the composition is included in the region circumscribed by a straight line \textcircled{2}-\textcircled{3}, a straight line \textcircled{3}-\textcircled{4}, a straight line \textcircled{4}-\textcircled{5}, and a straight line \textcircled{5}-\textcircled{2}, in which these lines are formed by joining point \textcircled{2} (1.60, 5.0), point \textcircled{3} (2.55, 3.5), point \textcircled{4} (2.55, 1.0) and point \textcircled{5} (1.60, 1.0), respectively in the X-Y coordinate system.

Next, the adjacent solid composition can be precipitated by drying the solution for the adjacent solid composition under reduced pressure in the same manner as in the preparation of the amorphous solid composition of the present invention.

Next, the present invention will be described more specifically on the basis of the following examples and the like, without intending to limit the present invention only to those examples.

### Preparation Example 1

### Preparation of Solution for Amorphous Solid Composition

A 1000 mL flask was charged with 56.25 g of vanadium(III) oxide [V content: 67.91%] (V 38.21 g=0.75 mol) and 207.1 g of a 55% by weight aqueous sulfuric acid (H₂SO₄ 113.9 g=1.1625 mol), and the mixture was heated to 125° to 130° C. with stirring. As a result, a suspension of crystals of vanadium(III) sulfate hydrate (V₂(SO₄)₃.mH₂O in which m is an integer of 1 to 6, hereinafter referred to the same) was obtained.

Next, 174.2 g of vanadium(IV) sulfate hydrate (VOSO₄.nH₂O in which n is an integer of 4 to 6) [V content: 21.93%] (V 38.21 g=0.75 mol) and 220 mL of water were added to this suspension, and the mixture obtained was heated to 100° to 110° C. with stirring. Thereafter, insoluble materials contained in a slight amount were removed by filtration, and water was then added to the filtrate to adjust its liquid volume to 500 mL, to give a solution for a solid composition.

The solution for an amorphous solid composition thus obtained was a solution having a molar ratio of the trivalent vanadium ions to the tetravalent vanadium ions (ratio of a value obtained by dividing the content (weight) of the trivalent vanadium ions by 50.94 to a value obtained by dividing the content (weight) of the tetravalent vanadium ions by 50.94, hereinafter referred to the same) of 0.498:0.502, a sulfuric acid concentration (Z) of 3.825 mol/L, and a ratio (X) of the sulfuric acid concentration (Z) to the total amount (Y),i.e. 3 mol/L of the tetravalent vanadium ions and the trivalent vanadium ions of 1.275.

### Preparation Example 2

### Preparation of Solution for Amorphous Solid Composition

A 1000 mL flask was charged with 70.3 g of vanadium(III) oxide [V content: 67.91%] (V 47.74 g=0.938 mol) and 335.0 g of a 55% by weight aqueous sulfuric acid (H₂SO₄ 184.25 g=1.88 mol), and the mixture was heated to 115° to 125° C. with stirring. As a result, a solution in which crystals of vanadium(III) sulfate hydrate (V₂(SO₄)₃-mH₂O) were suspended was obtained.

Next, 28.5 g of vanadium oxide (purity as V₂O₅, 99.7%) (V 15.9 g=0.313 mol) and 290 mL of water were added to this suspension, and the mixture obtained was heated to 100° to 110° C. with stirring. Thereafter, insoluble materials contained in a slight amount were removed by filtration, and water was added to the filtrate to adjust its liquid volume to 500 mL, to give a solution for an amorphous solid composition.

The solution for an amorphous solid composition thus obtained was a solution having a molar ratio of the trivalent vanadium ions to the tetravalent vanadium ions of 0.503:0.497, a sulfuric acid concentration (Z) of 3.75 mol/L, and a ratio (X) of the sulfuric acid concentration (Z) to the total amount (Y), i.e. 2.5 mol/L of the tetravalent vanadium ions and the trivalent vanadium ions of 1.50.

### Preparation Example 3

### Preparation of Solution for Solid Composition

A 1000 mL flask was charged with 62.2 g of a lower oxide of vanadium [V(III) 40.96%] (V content: 25.48 g=0.500 mol) and V(IV) 24.01% (V content 14.93 g=0.293 mol) and 187.6 g of a 65% by weight aqueous sulfuric acid (1.243 mol), and the mixture was heated to 115° to 125° C. with stirring. As a result, a suspension in which crystals of vanadium(III) sulfate hydrate [V₂(SO₄)₃-mH₂O] were suspended was obtained.

Next, 48.01 g of vanadium(IV) oxide [VOSO₄.nH₂O] (V content: 21.93%) (V content 10.54 g=0.207 mol) (SO₄²⁻ content 0.207 equivalents) and 280 mL of water were added to this suspension, and the mixture obtained was heated to 100° to 110° C. with stirring. Thereafter, insoluble materials contained in a slight amount were removed by filtration, and water was then added to the filtrate to adjust its liquid volume to 500 mL, to give a solution for an amorphous solid composition.

The solution for an amorphous solid composition thus obtained was a solution having a molar ratio of the trivalent vanadium ions to the tetravalent vanadium ions of 0.502:0.498, a sulfuric acid concentration (Z) of 3.10 mol/L and a ratio (X) of the sulfuric acid concentration (Z) to the total amount (Y), i.e. 2.00 mol/L of the tetravalent vanadium ions and the trivalent vanadium ions of 1.55.

### Reference Example 1

### Preparation of Solution for Adjacent Solid Composition

A 1000 mL flask was charged with 62.2 g of a lower oxide of vanadium [V(III) 40.96%] (V content 25.48 g=0.500 mol) and V(IV) 24.01% (V content 14.93 g=0.293 mol) and 270.3 g of 65% by weight aqueous sulfuric acid (1.793 mol), and the mixture was heated to 115° to 125° C. with stirring. As a result, a suspension in which crystals of vanadium(III) sulfate hydrate [V₂(SO₄)₃.mH₂O] were suspended was obtained.

Next, 48.01 g of vanadium(IV) sulfate [VOSO₄.nH₂O] (V content 21.93%) (V 10.54 g=0.207 mol) and 240 mL of water were added to this suspension, and the mixture obtained was heated to 100° to 110° C. with stirring. Thereafter, insoluble materials contained in a sight amount were removed by filtration, and water was added to the filtrate to adjust its liquid volume to 500 mL, to give a solution for an adjacent solid composition.

The solution for the solid composition thus obtained was a solution having a molar ratio of the trivalent vanadium ions to the tetravalent vanadium ions of 0.502:0.498, a sulfuric acid concentration (Z) of 4.00 mol/L, and a ratio X of the sulfuric acid concentration (Z) to the total amount (Y), i.e. 2.00 mol/L of the tetravalent vanadium ions and the trivalent vanadium ions of 2.00.

### Examples 1 to 14, Reference Examples 2 to 18 and Comparative Examples 1 to 7

As the solution for the amorphous solid composition of the present invention and the solution for the adjacent solid composition, solutions which were included in the following specific X-Y region were prepared by a method as shown in Preparation Examples 1 and 2 and Reference Example 1.

The values included in the following specific X-Y region mean the values when the amorphous solid composition of the present invention and the adjacent solid composition can be easily obtained by evaporating the solution to dryness as explained below.

In the X-Y coordinate system of the solution for a solid composition described below, X and Y are defined as follows:

The total concentration of the tetravalent vanadium and the trivalent vanadium of the solution for a solid composition is defined as Y mol/L, a sulfuric acid concentration is defined as Z mol/L, and their ratio is defined as X=Z/Y.

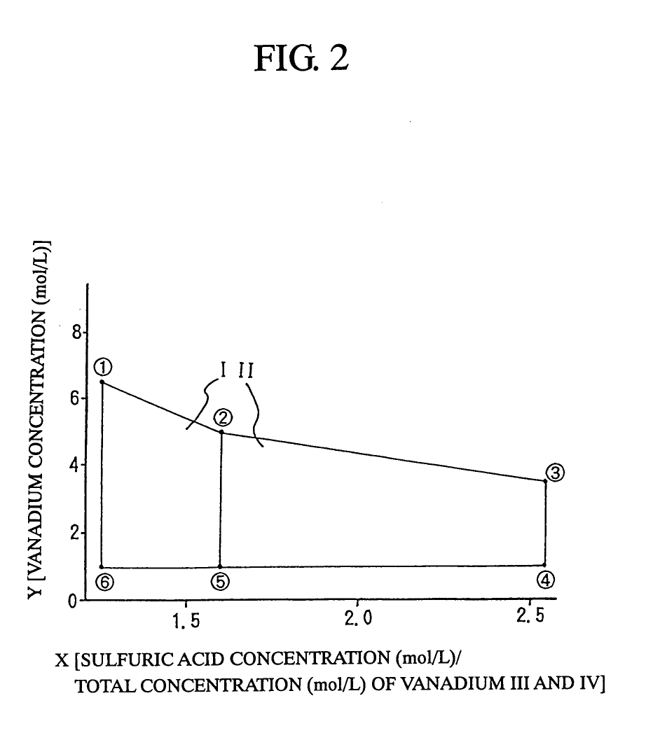

In the X-Y coordinate system, the region of X-Y for obtaining the amorphous solid composition is a region I circumscribed by a straight line \textcircled{1}-\textcircled{2}, a straight line \textcircled{2}-\textcircled{5}, a straight line \textcircled{5}-\textcircled{6} and a straight line \textcircled{5}-\textcircled{6}, in which these lines are formed by joining point \textcircled{1} (1.25, 6.5), point \textcircled{2} (1.60, 5.0), point \textcircled{5} (1.60, 1.0) and point \textcircled{6} (1.25, 1.0), respectively as shown in FIG. 2.

In the same manner as in the above, in the X-Y coordinate system, the region of X-Y for obtaining the adjacent solid composition is a region II circumscribed by a straight line \textcircled{2}-\textcircled{3}, a straight line \textcircled{3}-\textcircled{4}, a straight line \textcircled{4}-\textcircled{5} and a straight line \textcircled{5}-\textcircled{2}, in which these lines are formed joining point \textcircled{2} (1.60, 5.0), point \textcircled{3} (2.55, 3.5), point \textcircled{4} (2.55, 1.0) and point \textcircled{5} (1.60, 1.0), respectively as shown in FIG. 2.

As explained above, the amorphous solid composition of the present invention can be obtained by concentrating the solution for a solid composition included in a specific range of the above-mentioned X-Y coordinate system by means of, for instance, evaporation or the like.

The solution for a solid composition included in the above-mentioned specific range was prepared, and introduced into a rotary evaporator. The solution was heated to 55° to 85° C. under reduced pressure of 20 to 30 Torr (2660 to 3990 Pa) to evaporate water. The heating temperature near to the end point of the evaporation, at which solids were precipitated, was controlled to the temperature as listed in Tables 1 to 3. In Tables 1 to 3, the data of the amorphous solid compositions obtained in Examples 1 to 14, the adjacent solid compositions obtained in Reference Examples 1 to 18 and the solid compositions obtained in Comparative Examples 1 to 7 are listed in order.

The analytical method and the like for the solid composition obtained in each of Examples, Reference Examples and Comparative Examples are shown below.

[Vanadium Content (y) of Solid Composition]

A solid composition was pulverized with a mortar so that its particle diameter was at most 150 μm. The vanadium content (y) (% by weight) of the pulverized product was determined by a potassium permanganate titration method.

[External Appearance and the like of Solid Composition]

The external appearance of a solid composition was observed by naked eyes, and at the same time, the properties were examined at room temperature (about 20° C.).

[Water Solubility]

Pulverized solid composition (amount converted to V 100%: 2.0 g) obtained by pulverizing the solid composition so that the particle diameter was at most 150 μm was added to 25 mL of water which was previously poured in a 50 mL beaker at 20° to 30° C., and the mixture obtained was stirred with a magnetic stirrer to determine the time period necessary for dissolving the pulverized solid composition in water.

TABLE 1

| | Solution for Concentration | | Concentration by Evaporation to Solidify | | | | |
|---|---|---|---|---|---|---|---|
| | by Evaporation | | | Temperature at | | Summary of Solid Composition | |
| | X (Based on | | x (Based on | End Point of | | External | |
| | V: Molar | Y (V Content) | V: Molar | Evaporation | y (V Content) | Appearance | Water |
| Ex. No. | Ratio) | (mol/L) | Ratio) | (° C.) | (% by wt.) | and the like | Solubility |
| 1 | 1.250 | 1.70 | 1.250 | About 90 | 21.49 | Deep Green, | Dissolved Within |
| | | | | | | Transparent | 1 minute by |
| | | | | | | Brittle Like | Stirring |
| | | | | | | Caramelo | |
| 2 | 1.250 | 1.70 | 1.250 | About 110 | 22.30 | Same as Above | Same as Above |
| 3 | 1.275 | 2.0 | 1.275 | About 55 | 20.30 | Same as Above | Same as Above |
| 4 | 1.275 | 2.0 | 1.275 | About 90 | 22.16 | Same as Above | Same as Above |
| 5 | 1.275 | 2.0 | 1.275 | About 90 | 22.42 | Same as Above | Same as Above |
| 6 | 1.275 | 2.0 | 1.275 | About 110 | 22.76 | Same as Above | Same as Above |
| 7 | 1.313 | 2.5 | 1.313 | About 90 | 21.40 | Same as Above | Same as Above |
| 8 | 1.350 | 2.18 | 1.350 | About 90 | 21.08 | Same as Above | Same as Above |
| 9 | 1.350 | 2.18 | 1.350 | About 90 | 21.31 | Same as Above | Same as Above |
| 10 | 1.375 | 4.025 | 1.375 | About 90 | 20.33 | Same as Above | Dissolved Within |
| | | | | | | | 2 minutes by |
| | | | | | | | Stirring |
| 11 | 1.375 | 4.025 | 1.375 | About 75 | 20.06 | Same as Above | Same as Above |
| 12 | 1.500 | 2.52 | 1.500 | About 90 | 20.09 | Same as Above | Dissolved Within |
| | | | | | | | 5 minutes by |
| | | | | | | | Stirring |
| 13 | 1.500 | 2.52 | 1.500 | About 75 | 19.21 | Same as Above | Same as Above |
| 14 | 1.500 | 2.33 | 1.500 | About 90 | 19.01 | Same as Above | Same as Above |

TABLE 2

| | Solution for Concentration by | | Concentration by Evaporation to Solidify | | | | |
|---|---|---|---|---|---|---|---|
| | Evaporation | | | Temperature at | | Summary of Solid Composition | |
| | X (Based on | | x (Based on | End Point of | | External | |
| Ref. | V: Molar | Y (V Content) | V: Molar | Evaporation | y (V Content) | Appearance | Water |
| Ex. No. | Ratio) | (mol/L) | Ratio) | (° C.) | (% by wt.) | and the like | Solubility |
| 1 | 2.000 | 2.0 | 2.000 | About 85 | 16.46 | Yellow-Green | Dissolved |
| | | | | | | Crystal, Solidified | Within |
| | | | | | | | 15 minutes by |
| | | | | | | | Stirring |
| 2 | 1.625 | 1.62 | 1.625 | About 90 | 18.92 | Like Caramelo Not | Dissolved |
| | | | | | | Having Green | Within |
| | | | | | | Gloss | 10 minutes by |
| | | | | | | | Stirring |
| 3 | 1.625 | 1.62 | 1.625 | About 90 | 18.98 | Same as Above | Same as Above |
| 4 | 1.625 | 1.62 | 1.625 | About 75 | 17.76 | Same as Above | Same as Above |
| 5 | 1.690 | 2.16 | 1.690 | About 90 | 20.35 | Hard Like Caramelo | Same as Above |
| | | | | | | Not Having Green | |
| | | | | | | Gloss | |
| 6 | 1.690 | 2.17 | 1.690 | About 90 | 20.05 | Same as Above | Same as Above |
| 7 | 1.750 | 2.02 | 1.750 | About 90 | 19.85 | Same as Above | Same as Above |
| 8 | 1.750 | 2.02 | 1.750 | About 90 | 19.79 | Same as Above | Same as Above |
| 9 | 1.750 | 2.02 | 1.750 | About 110 | 19.76 | Same as Above | Same as Above |
| 10 | 1.813 | 2.39 | 1.813 | About 90 | 17.45 | Mixture of Yellow- | Same as Above |
| | | | | | | Green Crystals and | |
| | | | | | | Green Crystals | |
| | Solution for Concentration by | | Concentration and Evaporation to Solidify | | | | |
| | Evaporation | | | Temperature at | | Summary of Solid Composition | |
| | X (Based on | | x (Based on | End Point of | | External | |
| Ref. | V: Molar | Y (V Content) | V: Molar | Evaporation | y (V Content) | Appearance | Water |
| Ex. No. | Ratio) | (mol/L) | Ratio) | (° C.) | (% by wt.) | and the like | Solubility |
| 11 | 1.938 | 2.20 | 1.938 | About 90 | 18.39 | Mixture of Yellow- | Dissolved |
| | | | | | | Green Crystals and | Within |
| | | | | | | Green Crystals | 15 minutes by |
| | | | | | | | Stirring |
| 12 | 1.938 | 2.20 | 1.938 | About 90 | 17.75 | Same as Above | Same as Above |
| 13 | 2.200 | 2.0 | 2.200 | About 90 | 16.51 | Yellow-Green | Dissolved |
| | | | | | | Crystal, Solidified | Within |
| | | | | | | | 6 hours by |
| | | | | | | | Stirring |
| 14 | 2.250 | 2.0 | 2.250 | About 90 | 16.03 | Same as Above | Dissolved |
| | | | | | | | Within |
| | | | | | | | 10 hours by |
| | | | | | | | Stirring |
| 15 | 2.250 | 2.0 | 2.250 | About 110 | 17.50 | Same as Above | Same as Above |
| 16 | 2.530 | 2.18 | 2.530 | About 90 | 13.84 | Same as Above | Dissolved |
| | | | | | | | Overnight by |
| | | | | | | | Stirring |
| 17 | 2.530 | 2.18 | 2.530 | About 90 | 14.41 | Same as Above | Same as Above |
| 18 | 2.530 | 2.18 | 2.530 | About 110 | 14.81 | Same as Above | Same as Above |

TABLE 3

| | Solution for Concentration | | Concentration and Evaporation to Solidify | | | |
|---|---|---|---|---|---|---|
| | by Evaporation | | | Temperature at | | Summary of |
| | X (Based on | | x (Based on | End Point of | | Solid Composition |
| Comp. | V: Molar | Y (V Content) | V: Molar | Evaporation | y (V Content) | (External Appearance |
| Ex. No. | Ratio) | (mol/L) | Ratio) | (° C.) | (% by wt.) | and the like) |
| 1 | 1.275 | 2.0 | 1.275 | About 55 | 19.11 | Solidified from Syrupy |
| | | | | | | State After 2 to 3 Days |
| 2 | 1.750 | 2.02 | 1.750 | About 55 | 17.26 | Same as Above |
| 3 | 2.20 | 1.99 | 2.20 | About 55 | 14.22 | Same as Above |
| 4 | 2.20 | 1.99 | 2.20 | About 55 | 13.44 | Solidified from Syrupy |
| | | | | | | State After 4 to 5 Days |
| 5 | 2.20 | 1.99 | 2.20 | About 55 | 11.37 | Solidified from Solution |
| | | | | | | State After 10 Days |
| 6 | 2.53 | 2.18 | 2.53 | About 55 | 12.67 | Solidified from Adzuki- |
| | | | | | | Bean Jelly State on the |
| | | | | | | Next Day |
| 7 | 2.53 | 2.18 | 2.53 | About 55 | 10.84 | Solidified from Rice Cake |
| | | | | | | State After 1 to 2 Days |

As shown in Tables 1 to 3, it can be seen that the amorphous solid compositions of the present invention are obtained in Examples 1 to 14, and that the adjacent solid compositions are obtained in Reference Examples 1 to 18.

Also, it can be seen that all of the compositions obtained in Comparative Examples 1 to 7 are excluded from the ranges of the amorphous solid composition of the present invention and the adjacent solid composition, and that according to these Comparative Examples, amorphous solid compositions and analogous compositions thereof which satisfy the objects of the present invention cannot be obtained.

In view of the results mentioned above, the amorphous solid composition of the present invention will be discussed.

A value obtained by dividing the total amount of the tetravalent vanadium ions and the trivalent vanadium ions by the formula weight of vanadium, i.e. 50.94 is defined as a value, a value obtained by dividing the content of sulfate ions contained in the composition by the formula weight of SO₄²⁻, i.e. 96.1 is defined as b value, and a value obtained by dividing b value by a value is defined as x value [although being lacking in strictness, x value can be regarded as a molar ratio of sulfuric acid to vanadium if simply expressed]. The minimum x value necessary for transforming the tetravalent vanadium compound and the trivalent vanadium compound used as the raw materials into VOSO₄-nH₂O and V₂(SO₄)₃.mH₂O or their ionized forms is 1.25 which is obtained by the equation:
x=(1+1.5)/2=1.25.

Accordingly, it is thought that the composition formula of the solid composition not containing excess H₂O and H₂SO₄ obtained at x=1.25 is represented by [V₂(SO₄)₃₊₂VOSO₄]. Therefore, Ψ value which is a calculated value (%) of the V content in the component is obtained by the equation:
Ψ=4V/(4V+5SO₄+2×O)=28.47%
in accordance with the equation:

Ψ=4V/[V₂(SO₄)₃₊₂VOSO₄].

However, it was found out that the found value y is clearly lower than this Ψ value, and that the value y is within the range between about 23.2 and about 20.3 since the value y is controlled by the conditions of evaporation to dryness.

Also, when x value is 1.50, a solid composition containing free (1.50 to 1.25)H₂SO₄ and not containing excess water. Therefore, Ψ value which is a calculated value (%) of the V content in the component is obtained by the equation:
Ψ=4V/[(4V+5SO₄₊₂×O)+4(1.50−1.25)H₂SO₄]=25.04%.

Also, when Ψ is calculated in the same manner as the above at x=1.75, Ψ=4V/[(4V+5SO₄₊₂×0)+4(1.75−1.25) H₂SO₄]=22.35%. When Ψ is calculated in the same manner as the above at x=2.00, Ψ=4V/[(4V+5SO₄₊₂×O)+4(2.00−1.25) H₂SO₄]=20.38%. When Ψ is calculated in the same manner as the above at x=2.25, Ψ=4V/[(4V+5SO₄₊₂×0)+4(2.25−1.25) H₂SO₄]=18.56%. When Ψ is calculated in the same manner as the above at x=2.50, Ψ=4V/[(4V+5SO₄₊₂×0)+4(2.50−1.25) H₂SO₄]=17.04%. When Ψ is calculated in the same manner as the above at x=2.75, Ψ=4V/[(4V+5SO₄₊₂×0)+4(2.75−1.25) H₂SO₄]=15.75%.

These Ψvalues calculated are plotted, the results of which are shown in FIG. 1. These points plotted are denoted by pointα, pointβ, pointγ, pointδ, pointε, point ζ, and point η in FIG. 1.

In the solid composition actually obtained, the region defined by each of x values and y values shown in Table 1 is clearly formed in the region lower than the line formed by joining point α, point β, point γ, point δ, point ε, point ζ and point η, as shown in FIG. 1. For instance, when x value is 1.25, it can be seen that y value is in a region lower than point a since y value exists within a range between 23.20 and 21.49.

This shows that all of the amorphous solid compositions of the present invention contain water which is not easily removed by evaporation to dryness.

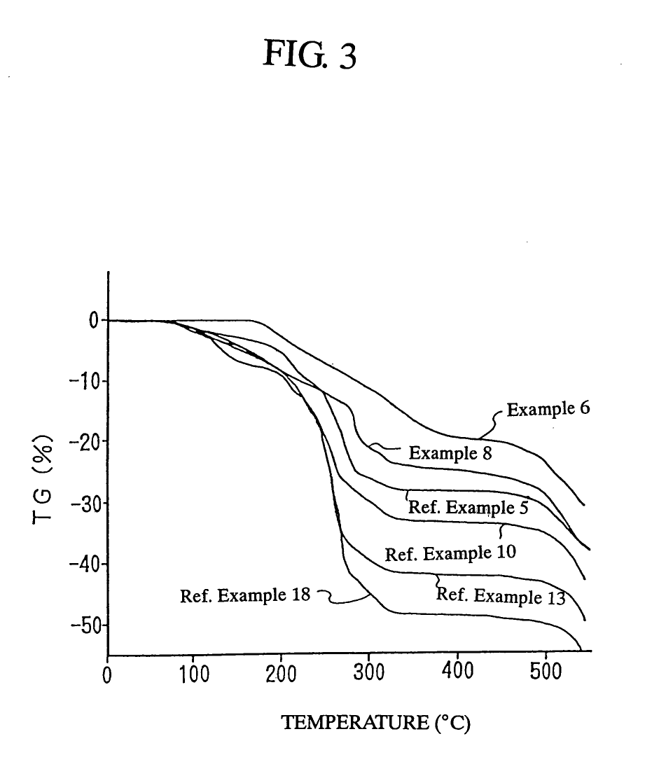

In order to clarify this fact, the thermogravimetric analysis of the solid compositions obtained in Example 6, Example 8, Reference Example 5, Reference Example 10, Reference Example 13 and Reference Example 18 was carried out. The results are shown in FIG. 3.

From the results shown in FIG. 3, the weight loss showing dehydration at 100° to 120° C. is scarcely observed when x value is 1.275 (Example 6). Also, when x value increases from 1.275 to 1.350 (Example 8), 1.690 (Reference Example 5), 1.813 (Reference Example 10), 2.200 (Reference Example 13), or 2.530 (Reference Example 18), it can be seen that the weight loss slightly increases, and the increase would remain within about 5%.

From this fact, according to the usual conditions for evaporation to dryness, since the heating temperature is at most 110° C., it can be said that the composition contains water which would not be removed by evaporation to dryness.

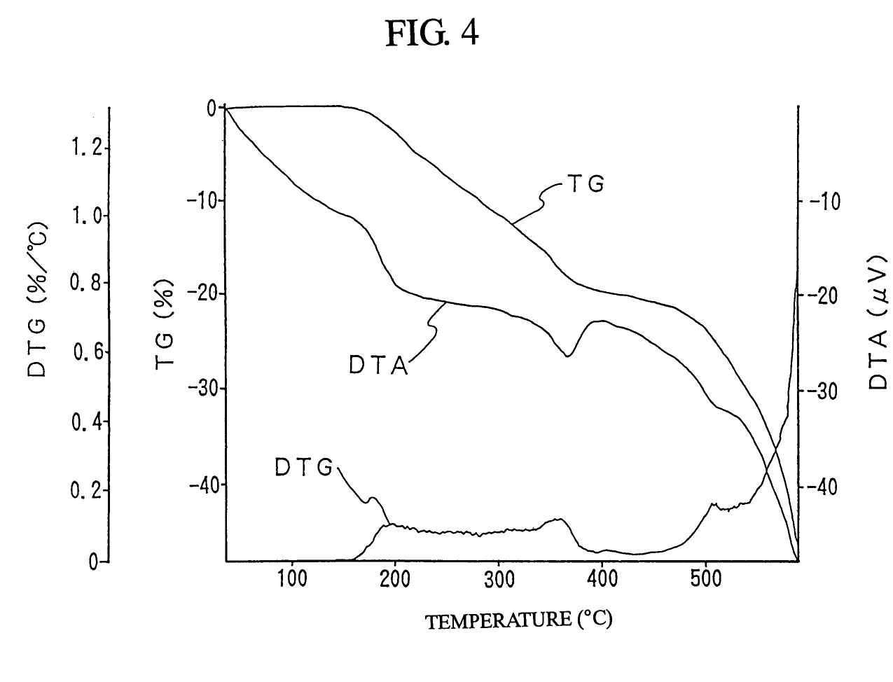

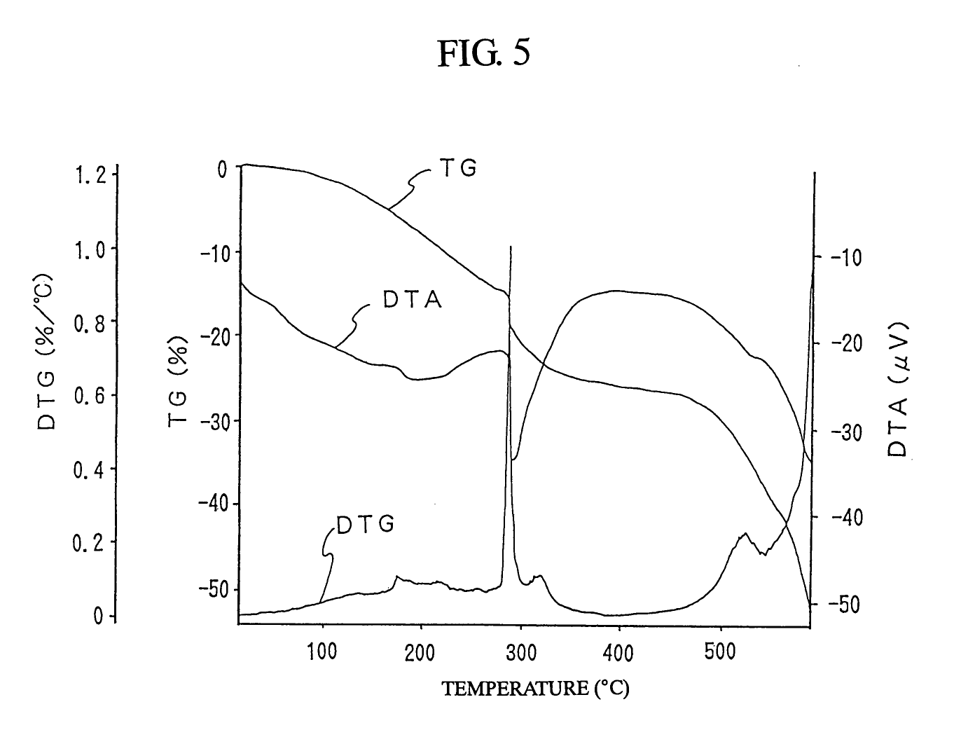

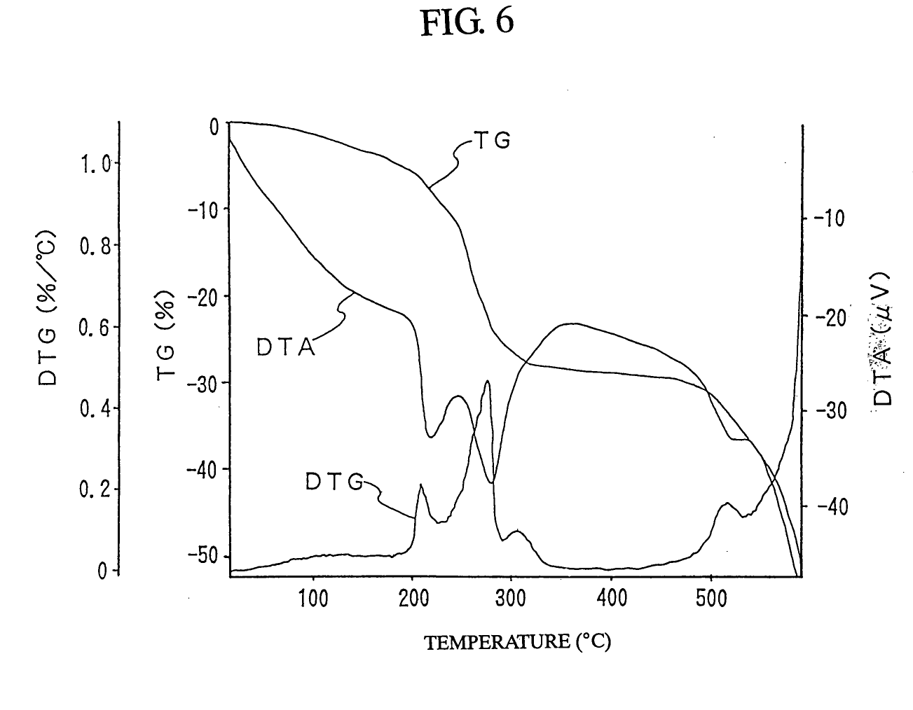

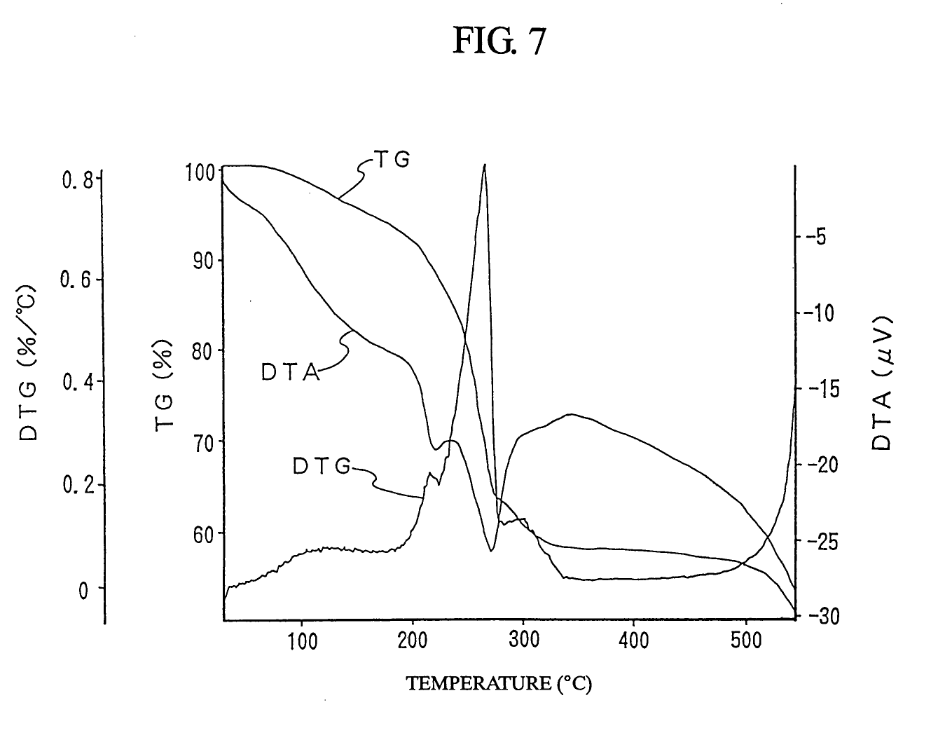

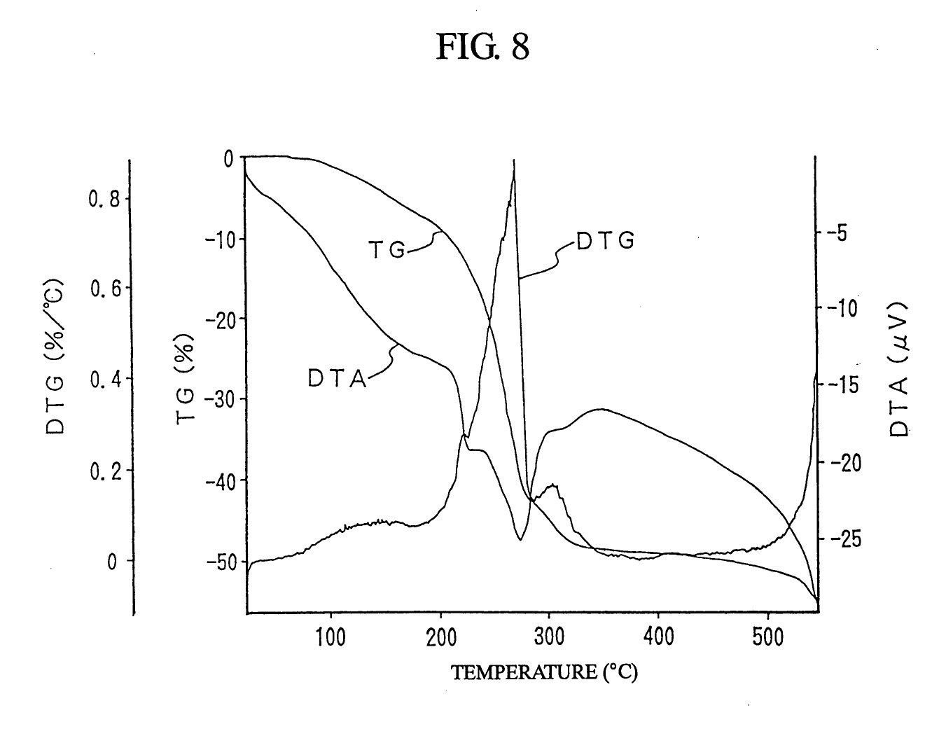

Furthermore, in order to clarify the dehydration loss of the solid compositions, thermogravimetric analysis (TG), derivative thermogravimetry (DTG) and differential thermal analysis (DTA) were simultaneously carried out for the solid compositions obtained in Example 6, Example 8, Reference Example 5, Reference Example 13 and Reference Example 18. Those results are shown in FIG. 4, FIG. 5, FIG. 6, FIG. 7 and FIG. 8 in order.

In each of FIGS. 4 to 8, the horizontal axis denotes temperature, the vertical axis denotes a value obtained by differentiating the curve of a weight change ratio (%) of a sample with respect to temperature as to DTG or a weight change ratio (%) of a sample as to TG, and μV is a potential difference between a standard substance (α-alumina) and a thermocouple for measuring the temperature of a sample.

It can be seen from these results that the peaks of the curves of the derivative thermogravimetry (DTG) and the differential thermal analysis (DTA) derived from dehydration are observed at around 180° C. and around 350° C. although they are broad when x value is 1.275 (Example 6). Also, when x value increases from 1.275 to 1.350 (Example 8), 1.690 (Reference Example 5), 2.200 (Reference Example 13) or 2.530 (Reference Example 18), it can be seen that the peaks become sharp, and that the peaks exist in a high temperature range of at least 180° C. In any case, a peak is revealed on the curve even at a temperature of at least 500° C. However, while the weight loss up to this stage exceeds 30% in total, the distance between the curve of Ψ value and the curve of y value as shown in FIG. 1 is about 25%. Therefore, it cannot be thought that the weight loss is only based upon dehydration, and it is thought that the decomposition will contribute to the weight loss.

When Tables 1 to 3 and FIG. 1 are specifically examined, it can be seen that y value differs depending upon the final temperature of the evaporation even at the same x value. Also, y value would not be completely constant when carried out the experiments plural times even at the same x value and the same final temperature of the evaporation.

It is thought that this is based upon that y value is easily influenced by a slight difference of the evaporation and solidification conditions, and that the solid composition obtained is hygroscopic.

On the other hand, it can be seen from the data of the compositions existing in the region lower than the lower limit of y value obtained in Comparative Examples 1 to 7 of Table 3 and FIG. 1 that even if a solid composition having a smaller y value is prepared by decreasing the temperature for evaporation to dryness, the resulting composition does not solidify and becomes syrupy or pasty like a rice cake.

Next, the amorphous solid composition of the present invention will be explained more specifically.

When Table 1 is specifically observed, there is a boundary in the compositions at the point where x value is around 1.60, and it can be seen that there is a difference in properties between the composition above the boundary and the composition below the boundary, that is, between the amorphous solid composition I of the present invention and the adjacent solid composition II.

In other words, when x value is within a range of 1.25 to 1.60, an amorphous solid composition I is obtained in the form of brittle glossy caramelo having a deep green color. Although the solution for a solid composition is a liquid having a high viscosity in the course of concentration in the preparation process, the solution is changed into a transparent solid like caramelo at the point where the content of water in the solution is reduced to a certain degree by evaporation.

This phenomenon is very similar to the formation of caramelo. The “formation of caramelo” as referred to herein means the formation of a brittle foamed substance made of sugar, which is prepared by adding water to sugar (crystal sugar), dissolving the sugar in water, thereafter concentrating the solution obtained with heating, adding sodium bicarbonate to the solution at a point where the solution becomes viscous, to foam the solution and at the same time excess water is removed.

On the other hand, in the region where x value is greater than 1.60, the product obtained by the concentration becomes yellowish and its hardness increases. Also, in the region where x value is greater than 2.0, hard crystalline solids having green color are formed.

As is clear from this fact, it can be seen that properties of the solid compositions obtained are greatly different between in the region where x value is within the range of 1.25 to 1.60 and in the region where x value is within the range of 1.60 to 2.55.

The formed amorphous solid composition of the present invention is brittle and transparent. Therefore, the composition looks like glass at a glance. However, the composition does not melt by heating, although glass melts via a glass transition state.

Also, the formed amorphous solid composition of the present invention looks like grown crystals. However, it was found that the composition is amorphous by determining the powdered X-ray diffraction of the composition.

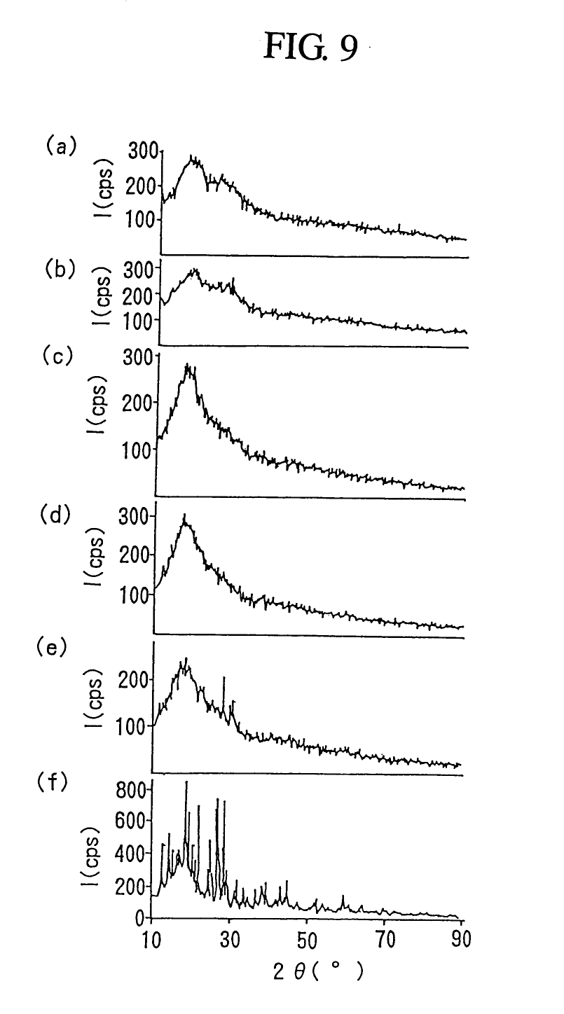

For instance, as is clear from the powdered X-ray diffraction pattern shown in FIG. 9(a) of the solid composition obtained in Example 6 (x=1.275), only a very wide broad peak is observed at 2θ=18.8°. Therefore, it can be seen that the formed amorphous solid composition of the present invention does not contain distinct crystals.

In the powdered X-ray diffraction patterns, the horizontal axis denotes diffraction angle (2θ), and the vertical axis denotes diffraction intensity I (counts per second: cps).

The powdered X-ray diffraction pattern of the solid composition obtained in Example 8 (x=1.35) is shown in FIG. 9(b).

According to the results shown in FIG. 9(b), only a wide broad peak is observed as well as the results as shown in FIG. 9(a), although the X-ray diffraction intensity increases around 2θ=27°. Therefore, it can be seen that the solid composition obtained in Example 8 also does not contain distinct crystals.

The powdered X-ray diffraction pattern of the amorphous solid composition obtained in Example 10 of the present invention (x=1.375) is shown in FIG. 9(c).

According to the results shown in FIG. 9(c), only a wide broad peak is observed as well as the results as shown in FIG. 9(a), although the X-ray diffraction intensity slightly increases around 2θ=27°. Therefore, it can be seen that the solid composition obtained in Example 10 also does not contain distinct crystals.

The powdered X-ray diffraction pattern of the amorphous solid composition obtained in Example 13 of the present invention (x=1.50) is shown in FIG. 9(d).

According to the results shown in FIG. 9(d), only a wide broad peak is observed as well as the results as shown in FIG. 9(a). Therefore, it can be seen that the solid composition obtained in Example 13 is also amorphous.

FIG. 9(e) shows an X-ray diffraction pattern of the amorphous solid composition obtained in Example 14. The composition has X=1.55 which is near the boundary to the adjacent solid composition. It is observed in the diffraction pattern that some weak diffraction peaks exist at around 2θ=28.5°, 30.0° and 31.0°. However, the diffraction pattern is similar to that of FIG. 9(a) on the whole, and the composition is an amorphous solid composition slightly having a tendency of crystallization.

Next, the water solubility of the amorphous solid composition of the present invention was evaluated. As a result, it was found that the composition has the property of dissolving very readily in water. The results of the water solubility determined are shown in Table 1.

It can be seen from the results shown in Table 1 that the solid composition is more dissolvable in water when x value of the solid composition approximates to 1.25, and that solubility of the solid composition is lowered in accordance with the increase of x value. However, it can be seen that the solid composition is excellent in water solubility even when x value exceeds 1.60.

When a value obtained by dividing the total amount of the tetravalent vanadium ions and the trivalent vanadium ions by 50.94 is defined as a value, and a value obtained by dividing the content of sulfate ions by 96.1 is defined as b value, as is clear from the results shown in Table 1 and FIG. 1, in accordance with the approximation of the value of x=b/a to 1.25, y value (total content (% by weight) of vanadium of the tetravalent vanadium ions and the trivalent vanadium ions) increases, and its maximum value attains to 23.20%.

The amorphous solid composition of the present invention contains water. Therefore, its y value is smaller than Ψ value (calculated value of the vanadium content [% by weight] when hypothesized that water is not contained in the composition) which exists in the upper portion of FIG. 1. Accordingly, when y value is kept to be high, it is preferable that the temperature in the final stage of the preparation is controlled to be high in order to reduce the amount of water.

However, it is supposed that dehydration partly occurs in the amorphous solid compositions obtained in Example 6 and Example 8 of the present invention at about 130° to about 170° C., for example, from the results of thermogravimetric analysis, derivative thermogravimetry and differential thermal analysis which were simultaneously determined, as shown in FIG. 4 and FIG. 5.

Accordingly, it is considered that dehydration occurs in the composition very little at a temperature for usual evaporation to dryness (at most 140° C.).

On the other hand, when 10 g of the amorphous solid composition of the present invention was allowed to stand in the air having a relative humidity of about 60° C., its weight increased to 10.8 g after 2 hours, and the composition became a hygroscopic lump of 12.7 g when allowed to stand overnight. From this result, it can be seen that the amorphous solid composition of the present invention has very high hygroscopic properties.

From these facts, it can be seen that there occurs phenomenon such that y value varies depending upon temperature, humidity or the like being employed in the preparation of the solid composition, even though x value is constant.

In addition, the amorphous solid composition of the present invention having y value (vanadium content in the solid composition) of, for instance, 23.20% by weight has a high concentration much greater than a conventional electrolyte (vanadium concentration: 2 mol/L, SO₄²⁻ concentration: 4 mol/L, y value: 7.90% by weight) and is solid at ordinary temperature, since y value of the amorphous solid composition is about 3 times as large as that of the conventional electrolyte. Therefore, the amorphous solid composition of the present invention is excellent in storage stability and stability in transportation.

In some cases, x value of the amorphous solid composition of the present invention is smaller than 1.5 to 2.55 which is x value of a composition used in a usual electrolyte. In those cases, sulfuric acid can be added to the solid composition instead that the composition is simply dissolved in water if necessary when preparing an electrolyte.

Next, the adjacent solid composition will be explained more specifically.

As is clear from the results of Reference Examples 1 to 18 (1.60<x≦2.55), the adjacent solid composition is a hard crystalline solid having yellow-green or green color.

The adjacent solid composition (x=1.625) obtained in Reference Example 2 was selected from the adjacent solid compositions obtained in Reference Examples 1 to 18, and its powdered X-ray diffraction was examined. The results are shown in FIG. 9(f).

In the powdered X-ray diffraction pattern shown in FIG. 9(f), it is difficult to specify the ascription of all of the peaks. However, there were observed some peaks (2θ=11.4°-11.5°, 19.7°-19.9°, 37.5°-37.6°) which would be ascribed to VOSO₄.3H₂O, a peak (2θ=18.6°) which would be ascribed to V₂SO₄.H₂O, and a peak (2θ=26.2°-26.3°) which would be ascribed to V₂S₄O₁₄.3H₂O. Also, a sharp diffraction peak showing the existence of a crystal is observed other than those peaks. It can be seen that the powdered X-ray diffraction pattern is quite different from the powdered X-ray diffraction patters of the solid compositions obtained in Examples 6, 8, 12 and 14 (FIGS. 9(a), (b), (c), (d) and (e)).

The water solubility of the solid composition obtained in each Example, each Reference Example and each Reference Example is shown in Tables 1 and 2. As is clear from the results shown in Tables 1 and 2, the solubility of the amorphous solid compositions obtained in the Examples of the present invention are a little lower than the adjacent solid compositions obtained in Reference Examples. However, it can be seen that those amorphous solid compositions can be suitably used as a raw material for electrolytes, since the amorphous solid compositions are more excellent in water solubility than the adjacent solid compositions.

Also, it can be seen that y value [vanadium content (% by weight)] of the adjacent solid compositions obtained in Reference Examples 1 to 18 is smaller than y value of the amorphous solid compositions obtained in Examples 1 to 14 of the present invention.

FIG. 3 shows the results of the determination of thermogravimetric analysis of the solid compositions obtained in Example 6, Example 8, Reference Example 5, Reference Example 10, Reference Example 13 and Reference Example 18, as mentioned above.

As is clear from the results shown in FIG. 3, it can be seen that the weight loss showing dehydration of the amorphous solid composition of the present invention is scarcely observed at a temperature of 100° to 120° C. when x value is 1.275 (Example 6), but the weight loss slightly increases when x value is 1.350 (Example 8).

Also, it can be seen that there is a tendency that the weight loss of the adjacent solid composition slightly increases at x=1.690 (Reference Example 5), x=1.813 (Reference Example 10), x=2.200 (Reference Example 13) and x=2.530 (Reference Example 18), but the increase of the weight loss is within the range of 5% or so.

An example of application of the amorphous solid composition of the present invention will be explained hereinbelow.

Application Example 1

To an aqueous sulfuric acid (liquid temperature: about 50° C.) made of 900 mL of water and 1.45 mol (45 g) of 98% sulfuric acid, was added with stirring 459.8 g of a transparent caramelo-like brittle amorphous solid composition having deep green color obtained in Example 4 of the present invention, the vanadium content of which was 22.16% by weight, and which contained 2 mol of V and 2.55 mol of H₂SO₄. As a result, the amorphous solid composition was completely dissolved in one minute.

This solution obtained was diluted with 1000 mL of water to give an electrolyte containing 2 mol/L of V and 4 mol/L of SO₂—.

This electrolyte was divided into two portions, and the electrolyte was poured into a positive electrode room and a negative electrode room of a small vanadium redox flow battery, respectively, and the battery was charged. Thereafter, discharge and charge were repeated 100 times. The property of the battery was found to be normal, and no unusual occurrence such as deterioration was found.

### INDUSTRIAL APPLICABILITY

The amorphous solid composition for a vanadium redox flow battery electrolyte of the present invention is solid and has a high content of vanadium. Therefore, the weight of the composition can be remarkably reduced in storage or transport, as compared with the electrolyte itself. Conventionally, a huge vessel for storing or transporting acidic liquids has been necessary for transporting the electrolyte. However, the amorphous solid composition of the present invention is very economical because the composition does not necessitate such a huge vessel.

An electrolyte can be arbitrarily and easily prepared from the amorphous solid composition of the present invention in accordance with the composition of the electrolyte required by a manufacturer of batteries. More specifically, the molar ratio of the tetravalent vanadium ions to the trivalent vanadium ions is controlled to 4.5:5.5 to 5.5:4.5 from the necessity for an electrolyte of batteries, and the total content of vanadium can be adjusted to be very high. Therefore, known electrolytes having a vanadium content of 1.5 to 2.5 mol/L can be easily prepared from the composition by selecting the amount of water or aqueous sulfuric acid. Furthermore, the ratio of the sulfuric acid content to the vanadium content can be adjusted so that the ratio is lower than the ratio in a known vanadium electrolyte. Therefore, when there is a necessity to prepare an electrolyte having a specified sulfuric acid content, which requires a higher content of sulfuric acid than this amorphous solid composition, the electrolyte for batteries can be very simply obtained only by properly adding sulfuric acid to this amorphous solid composition when preparing a solution of the amorphous solid composition.

1. An amorphous solid composition for a vanadium flow battery electrolyte comprising tetravalent vanadium ions, trivalent vanadium ions, water and sulfate ions, said solid composition being characterized in that the weight ratio of the vanadium content in the tetravalent vanadium ions to the vanadium content in the trivalent vanadium ions is 4.5:5.5 to 5.5:4.5, and that the composition exists within the region circumscribed by a straight line A-B, a straight line B-E, a straight line E-F and a straight line F-A, wherein these lines are formed by joining point A (1.25, 23.2), point B (1.25, 20.4), point E (1.60, 18.4) and point F (1.60, 21.2), respectively, in an x-y coordinate system in which the total vanadium content (% by weight) of the tetravalent vanadium ions and the trivalent vanadium ions in the composition is defined as a y-coordinate, a value obtained by dividing the total amount of the tetravalent vanadium ions and the trivalent vanadium ions by 50.94 is defined as a value, a value obtained by dividing the content of sulfate ions in the composition by 96.1 is defined as b value, and a value obtained by dividing b value by a value is defined as an x-coordinate.

2. The solid composition according to claim 1, wherein the tetravalent vanadium ion is represented by VO²⁺ or [VO(H₂O)₅]²⁺.

3. The solid composition according to claim 1, wherein the trivalent vanadium ions is represented by V³⁺ or [V(H₂O)₆]³⁺.
